(19) United States
(12) Patent Application Publication
(10) Pub. No.: US 2005/0212272 A1
(43) Pub. Date: Sep. 29, 2005

(54) Inflator with propelled fluid container

(75) Inventor: Homer W. Fogle JR., Mesa, AZ (US)

Correspondence Address: TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Automotive U.S. LLC

(21) Appl. No.: 10/806,700

(22) Filed: Mar. 23, 2004

(51) Int. Cl. B60R 21/26

(52) U.S. Cl. 280/737

(57) ABSTRACT

An inflator (10) comprising a housing (40) that includes at least one exit port (64) and a container (12) in which is stored a fluid (34) under pressure. The container (12) is located in the housing (40) and has opposite first and second ends (14 and 16). A tool (62) is located in the housing (40) adjacent the first end (14) of the container (12) for opening the first end (14) of the container (12). A pyrotechnic device (102) is located adjacent the second end (16) of the container (12) and is actuatable for propelling the container (12) through the housing (40) and into contact with the tool (62) so as to cause the tool (62) to open the first end (14) of the container (12) and enable a flow of fluid (34) from the container (12) toward the at least one exit port (64) of the housing (40).

### TECHNICAL FIELD

The present invention relates to an inflator, and particularly to an inflator for use in inflating an inflatable vehicle occupant protection device.

### BACKGROUND OF THE INVENTION

A conventional inflator for inflating an inflatable vehicle occupant protection device includes a container having a storage chamber. A rupture disk closes an open end of the container and seals the storage chamber. Inflation fluid under pressure is stored within the storage chamber. An initiator assembly is associated with the container and is located adjacent the rupture disk. The initiator is actuatable for bursting the rupture disk to enable inflation fluid to flow out of the storage chamber and toward the vehicle occupant protection device.

### SUMMARY OF THE INVENTION

The present invention relates to an inflator comprising a housing that includes at least one exit port. The inflator also comprises a container in which is stored a fluid under pressure. The container is located in the housing and has opposite first and second ends. A tool is located in the housing adjacent the first end of the container for opening the first end of the container. A pyrotechnic device is located adjacent the second end of the container and is actuatable for propelling the container through the housing and into contact with the tool so as to cause the tool to open the first end of the container and enable a flow of fluid from the container toward the exit port of the housing.

According to another aspect, the present invention relates to an inflator comprising a housing including at least one exit port. The inflator also comprises a container in which is stored a fluid under pressure. The container is located in the housing and has opposite first and second ends. A tool is located in the housing adjacent the first end of the container for opening the first end of the container. A device is actuatable for propelling the container through the housing and into contact with the tool so as to cause the tool to open the first end of the container and enable a flow of fluid from the container toward the exit port of the housing. A portion of the housing forms at least part of a stop mechanism for limiting movement of the container away from the tool in response to the flow of fluid from the container acting to propel the container away from the tool.

In accordance with yet another aspect, the present invention relates to an inflator comprising a plastic housing. At least one exit port extends through the plastic housing. A container, in which is stored a fluid under pressure, is located in the plastic housing. The inflator also comprises structure associated with the plastic housing and actuatable for propelling the container relative to the housing and into a tool for opening the container to enable a flow of fluid from the container toward the exit port of the plastic housing.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 is a cross-sectional view of an inflator constructed in accordance with the present invention and in a non-actuated condition;

FIG. 2 illustrates the inflator of FIG. 1 during actuation;

FIG. 3 illustrates the inflator of FIG. 1 in an actuated condition;

FIG. 4 is a cross-sectional view of an inflator constructed in accordance with a second embodiment of the present invention and in a non-actuated condition;

FIG. 5 illustrates the inflator of FIG. 4 in an actuated condition;

FIG. 6 is a cross-sectional view of an inflator constructed in accordance with a third embodiment of the present invention and in a non-actuated condition;

FIG. 7 illustrates the inflator of FIG. 6 in an actuated condition;

FIG. 8 is a cross-sectional view of an inflator constructed in accordance with a fourth embodiment of the present invention and in a non-actuated condition; and

FIG. 9 illustrates the inflator of FIG. 8 during actuation.

### DETAILED DESCRIPTION OF THE INVENTION

FIG. 1 is a cross-sectional view of an inflator 10 constructed in accordance with the present invention. FIG. 1 shows the inflator 10 in a non-actuated condition. The inflator 10 includes a container 12 having opposite first and second axial ends 14 and 16, respectively. The container 12 includes a tubular portion 18, a narrowed portion 20, and a hemispherical end portion 22. The narrowed portion 20 of the container 12 defines the first axial end 14 of the container. The first axial end 14 of the container includes a circular opening 24. The hemispherical end portion 22 of the container 12 defines the second axial end 16 of the container. The second axial end 16 of the container 12 is closed.

A rupture disk 26 closes the opening 24 in the first axial end 14 of the container 12. The rupture disk 26 is preferably made of metal and is welded to narrowed portion 20 of the container 12 to close the opening 24 in the first axial end 14. The rupture disk 26 includes opposite first and second surfaces 28 and 30, respectively, and is adapted to withstand a differential pressure between the first and second surfaces.

A storage chamber 32 is located within the container 12. When the rupture disk 26 closes the first axial end 14 of the container 12, the storage chamber 32 is sealed. Inflation fluid 34 under pressure is stored in the storage chamber 32. The inflation fluid 34 under pressure preferably includes one or more inert gases, such as helium or nitrogen. Preferably, at least one of the stored inert gases will be suitable as a leak detection tracer gas, for example, helium.

The inflator 12 also includes a housing 40. The housing 40 includes a tubular main body portion 42 having opposite first and second axial ends 44 and 46, respectively. In the embodiment illustrated in FIG. 1, the main body portion 42 is formed from high strength steel. The main body portion 42 of the housing 40 includes cylindrical inner and outer surfaces 48 and 50, respectively. The inner and outer surfaces 48 and 50 of the main body portion 42 are centered on axis A. A diameter of the inner surface 48 of the main body portion 42 is slightly larger than a diameter of the tubular portion 18 of the container 12. The inner surface 48 of the main body portion 42 is smooth and has a low coefficient of friction. Alternatively, the inner surface 48 may be coated with a material having a low coefficient of friction. Preferably, any coating applied to the inner surface 48 of the main body portion 42 will also have rust inhibiting characteristics.

The housing 40 of the inflator 10 also includes a closure member 54 for closing the first axial end 44 of the main body portion 42. The closure member 54 is cylindrical and is formed from high strength steel. A cylindrical outer surface 56 of the closure member 54 has a diameter that is approximately equal to the diameter of the inner surface 48 of the main body portion 42. The closure member 54 also includes opposite first and second radially extending side surfaces 58 and 60, respectively. A conical protrusion 62 extends outwardly of the center of the second side surface 60 of the closure member 54 and terminates in a point 64 at a location axially spaced away from the second side surface.

The housing 40 also includes four exit ports 64. Two of the exit ports 64 are shown in FIG. 1. The exit ports 64 extend axially through the closure member 54. As an alternative to, or in addition to, the exit ports 64 extending axially through the closure member 54, the exit ports 64 may extend radially through the main body portion 42 of the housing 40 at locations adjacent the closure member 54. The exit ports 64 enable the flow of inflation fluid 34 out of the housing 40.

The housing 40 also includes a breech block 70. The breech block 70 may be a metal casting or a molded thermoplastic part. The breech block 70 includes a cylindrical outer surface 72 and opposite first and second axial ends 74 and 76, respectively. The cylindrical outer surface 72 has a diameter that is approximately equal to the diameter of the inner surface 48 of the main body portion 42. A concave recess 78 extends axially into the first axial end 74 of the breech block 70. A tapered recess 80 extends into the second axial end 76 of the breech block 70. An axially extending bore 82 connects the two recesses 78 and 80.

The inflator 10 also includes an initiator retainer 86. The initiator retainer 86 includes an annular main body portion 88 that is sized to be received in the tapered recess 80 of the breech block 70. The main body portion 88 of the initiator retainer 86 includes first and second axial ends 90 and 92, respectively, and defines a central through hole 94. An annular flange 96 extends radially inwardly from the main body portion 88 into the through hole 94 near an axial midpoint of the initiator retainer 86. An annular flange 98 extends radially outwardly of the main body portion 88 of the initiator retainer 86 adjacent the second axial end 92. Although FIG. 1 shows the initiator retainer 86 as a separate structure from the breech block 70, the initiator retainer 86 may be formed as one piece with the breech block 70.

An initiator 102 of the inflator 10 includes a cylindrical portion 104 that contains a pyrotechnic charge (not shown) and a resistive wire (not shown) for igniting the pyrotechnic charge. The initiator 102 also includes a tapered support portion 106 and an end portion 108 having leads 110 for connecting the resistive wire of the initiator 102 to electronic circuitry (not shown) of a vehicle safety system. The pyrotechnic charge of the initiator is ignitable in response to the initiator receiving an actuation signal from the electronic circuitry.

The inflator 10 includes a spring 114 for limiting movement of the container 12 relative to the housing 40 prior to actuation of the initiator 102. The spring 114 is preferably a helical spring that acts between the second side surface 60 of the closure member 54 and the first axial end 14 of the container 12. The spring 114 helps to prevent unintentional actuation of the inflator 10. For example, the spring 114 may be designed to have a spring constant sufficient to resist movement of the container 12 relative to the housing 40 when the inflator 10 is dropped from a height of four feet.

The inflator 10 of FIG. 1 may also include a dust and debris shield 116. The dust and debris shield 116 of FIG. 1 is formed from a plastic film and prevents dust and other debris from entering the portion of the housing 40 in which the container 12 is stored. As an alternative to the dust and debris shield 116 illustrated in FIG. 1, the dust and debris shield may be attached to the closure member 54 so as to extend only over the exit ports 64. When located over the exit ports 64, the dust and debris shield is designed to burst upon the occurrence of a differential pressure acting across the dust and debris shield.

To assemble the inflator 10 of FIG. 1, the initiator 102 is inserted into the through hole 94 of the initiator retainer 86 from the first axial end 90 until the tapered support portion 106 of the initiator 102 abuts the flange 96 of the initiator retainer 86. The first axial end 90 of the main body portion 88 of the initiator retainer 86 is then crimped over the tapered support portion 106 to secure the initiator 102 relative to the initiator retainer 86. The initiator retainer 86 is then inserted into the tapered recess 80 of the breech block 70 so that the cylindrical portion 104 of the initiator 102 is located in the axially extending bore 82 of the breech block 70. The breech block 70, the initiator 102, and the initiator retainer 86 are inserted into the second axial end 46 of the main body portion 42 of the housing 40. A crimp 120 is formed on the second axial end 46 of the main body portion 42 for retaining the breech block 70, the initiator 102, and the initiator retainer 86 in the main body portion. In addition to the crimp 120, or as an alternative to the crimp 120, other means for retaining the breech block 70, the initiator 102, and the initiator retainer 86 in the main body portion 42 may be used. For example, the second axial end 46 of the main body portion 42 of the housing 40 and the initiator retainer 86 may be welded together.

The container 12, which was previously filled with inflation fluid 34 under pressure and sealed with the rupture disk 26, is then inserted into the first axial end 44 of the main body portion 42 so that the hemispherical end portion 22 of the container 12 engages the breech block 70. The dust and debris shield 116 is inserted into the first axial end 44 of the main body portion 42 and is secured to the main body portion 42 of the housing 40 so as to seal from dust and debris the portion of the housing in which the container 12 is located. Any suitable method for securing the dust and debris shield 116 to the inner surface 48 of the main body portion 42 may be used. For example, an adhesive may be used to secure the dust and debris shield 116 to the main body portion 42.

Next, the spring 114 is inserted into the first axial end 44 of the main body portion 42 of the housing 40 and placed in contact with the dust and debris shield 116 so as to act through the dust and debris shield on the first axial end 14 of the container 12. The second side surface 60 of the closure member 54 is pressed against the spring 114, and the closure member 54 is inserted into the first axial end 44 of the main body portion 42. During insertion of the closure member 54, the spring 114 is compressed between the closure member 54 and the container 12 and biases the container away from the conical protrusion 62.

A crimp 122 is formed on the first axial end 44 of the main body portion 42 for retaining the closure member 54 in the main body portion 42. In addition to the crimp 122, or as an alternative to the crimp 122, other means for retaining the closure member 54 in the main body portion 42 may be used. For example, the first axial end 44 of the main body portion 42 of the housing 40 and the closure member 54 may be welded together.

The inflator 10 is actuatable for providing inflation fluid. When the initiator 102 receives an actuation signal, the pyrotechnic charge of the initiator 102 is ignited. A pressure wave resulting from ignition of the pyrotechnic charge is directed toward the hemispherical end portion 22 of the container 12. The pressure wave acts upon the hemispherical end portion 22 of the container 12 forcing the container toward the first axial end 44 of the housing 40. The force imparted on the hemispherical end portion 22 of the container 12 overcomes the resistance of the spring 114 and the container 12 is propelled toward the first axial end 44 of the housing 40.

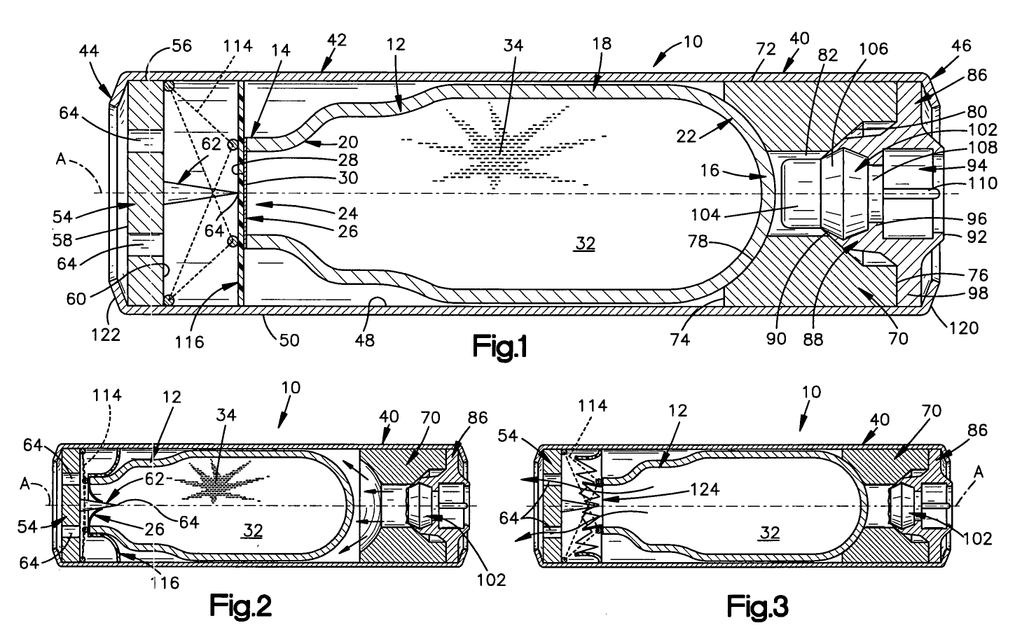

During movement of the container 12 toward the first axial end 44 of the housing 40, the container 12 tears the dust and debris shield 116 and the rupture disk 26 collides with the conical protrusion 62. The conical protrusion 62 penetrates through the rupture disk 26 creating a flow opening 124 (FIG. 3) in the rupture disk through which inflation fluid 34 exits the storage chamber 32. FIG. 2 illustrates the container 12 located adjacent the first axial end 44 of the housing 42 with the conical protrusion 62 penetrating the rupture disk 26.

The force resulting from the flow of inflation fluid 34 out of the container 12 through the flow opening 124, along with the force of the spring 114 acting upon the first axial end 14 of the container 12, forces the container 12 back toward the second axial end 46 of the housing 40. When the fluid flow force and the spring force combine to overcome the force resulting from the pressure wave of the actuated initiator 102, the container 12 is propelled back toward the second axial end 46 of the housing 40. The hemispherical end portion 22 of the container 12 is forced into contact with the breech block 70, and the breech block stops the container. FIG. 3 illustrates the container 12 in contact with the breech block 70 of the housing 40 with inflation fluid (illustrated by arrows) flowing out of the container 12. Inflation fluid flowing from the container 12 passes through the exit ports 64 in the closure member 54 to exit the housing 40.

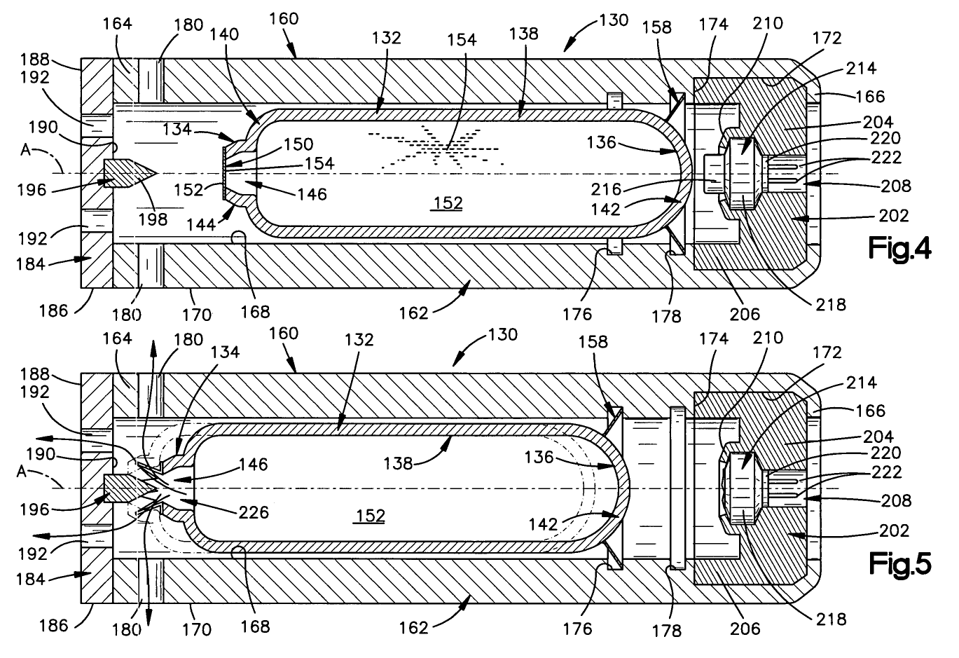

FIG. 4 is a cross-sectional view of an inflator 130 constructed in accordance with a second embodiment of the present invention. The inflator 130 of FIG. 4 is in a non-actuated condition. The inflator 130 includes a container 132. The container 132 is generally cylindrical and has opposite first and second axial ends 134 and 136, respectively. The container 132 includes a tubular portion 138, a first end portion 140 and a second end portion 142. The tubular portion 138 is centered on axis A. The first end portion 140 defines the first axial end 134 of the container 132. The first end portion 140 includes a mouth 144 of the container 132. A circular opening 146 extends through the mouth 144 of the container 132. The second end portion 142 defines the second axial end 136 of the container 132. The second end portion 142 is hemispherical and closes the second axial end 136 of the container 132.

A rupture disk 150 closes the opening 146 in the first axial end 134 of the container 132. The rupture disk 150 is preferably made of metal and is welded to mouth 144 of the first end portion 140 to close the opening 146 in the first axial end 134 of the container 132. The rupture disk 150 includes opposite first and second radially extending surfaces 152 and 154, respectively. The rupture disk 150 is adapted to withstand a differential pressure between the first and second surfaces 152 and 154.

A storage chamber 152 is located within the container 132. When the rupture disk 150 closes the first axial end 134 of the container 132, the storage chamber 152 is sealed. Inflation fluid 154 under pressure is stored in the storage chamber 152. The inflation fluid 154 under pressure preferably includes one or more inert gases. Preferably, at least one of the stored inert gases will be suitable as a leak detection tracer gas.

A locking member 158 is fixedly attached to the second end portion 142 of the container 132. The locking member 158 is a frustoconical ring that is formed from a flexible steel material. A central opening of the locking member 158 is smaller in diameter than the tubular portion 138 of the container 132 but large enough to receive part of the second end portion 142 of the container. The locking member 158 is preferably welded to the second end portion 142 of the container 132 so that the locking member 158 extends radially outwardly relative to axis A at an angle of approximately forty-five degrees and in a direction away from the first axial end 134 of the container 132.

The inflator 130 also includes a housing 160. The housing 160 includes a tubular main body portion 162 having opposite first and second axial ends 164 and 166, respectively. In the embodiment illustrated in FIG. 4, the main body portion 162 is formed from high strength steel. The main body portion 162 includes cylindrical inner and outer surfaces 168 and 170, respectively. The inner and outer surfaces 168 and 170 of the main body portion 162 are centered on axis A. A diameter of the inner surface 168 of the main body portion 162 is slightly larger than a diameter of the tubular portion 138 of the container 132 and slightly smaller than an outer diameter of the locking member 158. The inner surface 168 of the main body portion 162 is smooth and has a low coefficient of friction. Alternatively, the inner surface 168 may be coated with a material having a low coefficient of friction. Preferably, any coating applied to the inner surface 162 of the main body portion 168 will also have rust inhibiting characteristics.

An axially elongated circumferential groove 172 extends into the inner surface 168 of the main body portion 162 adjacent the second axial end 166. The axially elongated groove 172 extends over approximately twenty percent of the axial length of the housing 160 and terminates at a radially extending edge surface 174. First and second circumferential grooves 176 and 178, respectively, also extend into the inner surface 168 of the main body portion 162. The first circumferential groove 176 is located nearer the first axial end 164 of the housing 160, relative to the second circumferential groove 178, and is spaced from the edge surface 174 by a distance of approximately another ten percent of the axial length of the housing 160. The second circumferential groove 178 is located adjacent the edge surface 174 and is spaced a short distance away from the axially elongated groove 172.

The main body portion 162 of the housing 160 also includes four radially extending exit ports 180. Only two of the exit ports 180 are shown in FIG. 4. The exit ports 180 are located adjacent the first axial end 164 of the main body portion 162 and extend through the main body portion from the inner surface 168 to the outer surface 170.

The housing 160 of the inflator 130 also includes a closure member 184 for closing the first axial end 164 of the main body portion 162. The closure member 184 is cylindrical and is formed from high strength steel. A cylindrical outer surface 186 of the closure member 184 has a diameter that is approximately equal to the diameter of the outer surface 170 of the main body portion 162. The closure member 184 also includes opposite first and second radially extending side surfaces 188 and 190, respectively. Four exit ports 192 extend through the closure member. Only two of the exit ports 192 are shown in FIG. 4.

A tool 196 is affixed to the second side surface 190 of the closure member 184 and extends axially from the second side surface 190 of the closure member 184. The tool 196 is generally cylindrical and terminates in a conical portion 198 on an end opposite the closure member 184. The tool 196 is preferably made from steel.

The inflator 130 also includes an initiator retainer 202. The initiator retainer 202 includes a bottom portion 204 and a wall portion 206. The wall portion 206 is annular and extends axially away from the bottom portion 204. A through hole 208 extends axially through the center of a bottom portion 204. An annular flange 210 extends axially away from the bottom portion 204 of the initiator retainer 202 in a direction parallel to the wall portion 206. The annular flange 210 surrounds the through hole 208.

An initiator 214 of the inflator 130 includes a cylindrical portion 216 that contains a pyrotechnic charge (not shown) and a resistive wire (not shown) for igniting the pyrotechnic charge. The initiator 214 also includes a larger diameter cylindrical support portion 218 and an end portion 220 having leads 222 for connecting the resistive wire to electronic circuitry (not shown) of a vehicle safety system. The pyrotechnic charge of the initiator 214 is ignitable in response to the initiator receiving an actuation signal from the electronic circuitry.

To assemble the inflator 130 of FIG. 4, the closure member 184 is fixedly attached to the first axial end 164 of the main body portion 162 of the housing 160 so that the tool 196 is located within the housing. The container 132, which was previously filled with inflation fluid 154 under pressure and sealed with the rupture disk 150, is then inserted into the second axial end 166 of the main body portion 162 of the housing 160. The container 132 is inserted into the main body portion 162 of the housing 160 until the locking member 158 is located in the second circumferential groove 178.

The initiator 214 is inserted into the through hole 208 in the initiator retainer 202 and the annular flange 210 is crimped over the support portion 218 of the initiator 214 to secure the initiator to the initiator retainer 202. The initiator retainer 202 is then inserted into the second axial end 166 of the main body portion 162 of the housing 160 so that the bottom portion 204 of the initiator retainer 202 is adjacent the second axial end 166 and the wall portion 206 engages the radially extending edge surface 174. The second axial end 166 of the main body portion 162 of the housing 160 is crimped to secure the initiator retainer 202 within the housing.

The inflator 130 of FIG. 4 is actuatable for providing inflation fluid. When the initiator 214 receives an actuation signal, the pyrotechnic charge of the initiator 214 is ignited. A pressure wave resulting from ignition of the pyrotechnic charge is directed toward the second end portion 142 of the container 132. The pressure wave acts upon the second end portion 142 of the container 132, forcing the container toward the first axial end 164 of the housing 160. The locking member 158 acts as a spring to resists movement of the container 132 toward the first axial end 164. When the pressure acting on the second end portion 142 of the container 132 overcomes the resistance of the locking member 158, the container 132 is propelled toward the first axial end 164 of the housing 160. The locking member 158 is deformed radially inwardly, relative to axis A, when the container 132 moves relative to the housing 160 and the locking member 158 is removed from the second circumferential groove 178. During movement of the container 132 relative to the housing 160, the locking member 158 slides on the inner surface 168 of the main body portion 162.

During movement of the container 132 toward the first axial end 164 of the housing 160, the rupture disk 150 strikes the tool 196. The tool 196 penetrates through the rupture disk 150, creating a flow opening 226 (FIG. 5) in the rupture disk 150. Inflation fluid 154 begins to flow out of the container 132 through the flow opening 226.

The force resulting from the flow of inflation fluid 154 out of the container 132 forces the container away from the tool 196 and back toward the second axial end 166 of the housing 160. When the force of the fluid flow overcomes the pressure wave resulting from the ignition of initiator 214, the container 132 is moved back toward the second axial end 166 of the housing 160. During movement of the container 132 toward the second axial end 166 of the housing 160, the locking member 158 enters the first circumferential groove 176 and acts to prevent further movement of the container 132 toward the second axial end 166 of the housing 160. FIG. 5 illustrates the locking member 158 in the first circumferential groove 176 and preventing movement of the container 132 toward the second axial end 166 of the housing 160. Inflation fluid 154 flowing from the container 132 exits the housing through the exit ports 180 and 192.

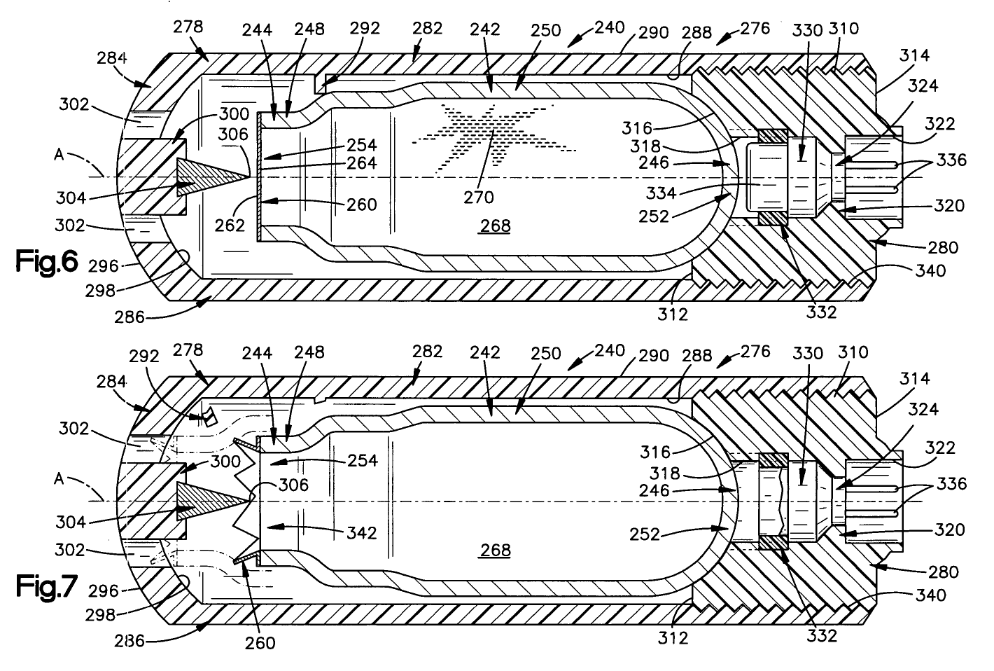

FIG. 6 is a cross-sectional view of an inflator 240 constructed in accordance with a third embodiment of the present invention. The inflator 240 of FIG. 6 is in a non-actuated condition. The inflator 240 includes a container 242 having opposite first and second axial ends 244 and 246, respectively. The container 242 includes a narrowed portion 248, a tubular portion 250, and a hemispherical end portion 252. The narrowed portion 248 of the container 242 defines the first axial end 244 of the container. The first axial end 244 of the container 242 includes a circular opening 254. The hemispherical end portion 252 of the container 242 defines the second axial end 246 of the container. The second axial end 246 of the container 242 is closed.

A rupture disk 260 closes the opening 254 in the first axial end 244 of the container 242. The rupture disk 260 is preferably made of metal and is welded to narrowed portion 248 of the container 242 to close the opening 254 in the first axial end 244. The rupture disk 260 includes opposite first and second radially extending surfaces 262 and 264, respectively, and is adapted to withstand a differential pressure between the first and second surfaces.

A storage chamber 268 is located within the container 242. When the rupture disk 260 closes the first axial end 244 of the container 242, the storage chamber 268 is sealed. Inflation fluid 270 under pressure is stored in the storage chamber 268. The inflation fluid 270 under pressure preferably includes one or more inert gases. Preferably, at least one of the stored inert gases will be suitable as a leak detection tracer gas.

The inflator 240 also includes a molded plastic housing 276. The housing 276 includes a main body portion 278 and a breech block portion 280. The main body portion 278 of the housing 276 is molded as one piece and includes a tubular portion 282 and an end portion 284 that closes a first axial end 286 of the tubular portion. The tubular portion 282 of the main body portion 278 includes cylindrical inner and outer surfaces 288 and 290, respectively. The inner and outer surfaces 288 and 290 are centered on axis A. A diameter of the inner surface 288 of the main body portion 278 is slightly larger than a diameter of the tubular portion 250 of the container 242. The inner surface 288 of the main body portion 278 is smooth and has a low coefficient of friction. A tab 292 extends radially inwardly from the inner surface 288 of the tubular portion 282 at a location approximately twenty percent of the axial length of the tubular portion from the end portion 284.

The end portion 284 of the main body portion 278 of the housing 276 includes a convex outer surface 296 and a concave inner surface 298. A cylindrical protrusion 300 extends axially along axis A away from the inner surface 298 of the end portion 284. Four exit ports 302 extend axially through the end portion 284. Only two of the exit ports 302 are shown in FIG. 6. Alternatively, the exit ports 302 may extend radially through the tubular portion 282 of the main body portion 278 of the housing 276. The exit ports 302 enable inflation fluid flow out of the housing 276.

A conical tool 304 extends away from the distal end of the cylindrical protrusion 300 of the end portion 284. The conical tool 304 is preferably made from steel. Preferably, a wide end of the conical tool 304 is molded into the cylindrical protrusion 300. The conical tool 304 terminates in a point 306 at a location axially spaced away from the cylindrical protrusion 300.

The breech block portion 280 of the housing 276 is formed as one piece from a molded thermoplastic material. The breech block portion 280 includes a cylindrical outer surface 310 and opposite first and second axial ends 312 and 314, respectively. The cylindrical outer surface 310 has a diameter that is approximately equal to the diameter of the inner surface 288 of the tubular portion 282 of the main body portion 278 of the housing 276. A concave recess 316 extends into the first axial end 312 of the breech block 280. A first hole 318 extends axially into the first axial end 312 of the breech block 280 from the concave recess 316 and terminates at a tapered shoulder 320. A second hole 322 extends axially into the second axial end 314 of the breech block 280. A small diameter passage 324 connects the first and second holes 318 and 322.

The inflator 240 also includes an initiator 330 and a retainer ring 332 for securing the initiator relative to the breech block 280. The initiator 330 includes a cylindrical portion 334 that contains a pyrotechnic charge (not shown) and a resistive wire (not shown) for igniting the pyrotechnic charge. The initiator 330 also includes leads 336 for connecting the resistive wire to electronic circuitry (not shown) of a vehicle safety system. The pyrotechnic charge of the initiator 330 is ignitable in response to the initiator receiving an actuation signal from the electronic circuitry. The retainer ring 332 is annular and includes an inner diameter sized to receive the cylindrical portion 334 of the initiator 330 and an outer diameter sized slightly larger than the diameter of the first hole 318 in the breech block portion 280.

To assemble the inflator 240 of FIG. 6, the initiator 330 is inserted into the first hole 318 of the breech block portion 280 of the housing 276. The retainer ring 332 is pressed into the first hole 318 of the breech block portion 280 so that the retainer ring 332 receives the cylindrical portion 334 of the initiator 330. The retainer ring 332 secures the initiator 330 in the first hole 318 and against the tapered shoulder 320.

The container 242, which was previously filled with inflation fluid 270 under pressure and sealed with the rupture disk 260, is then inserted into the tubular portion 282 of the housing 276 so that the narrowed portion 248 of the container 242 contacts the tab 292, as is shown in FIG. 6. The first axial end 312 of the breech block portion 280 is then inserted into the tubular portion 282 moved toward the container 242 until the concave recess 316 of the first axial end of the breech block portion receives the hemispherical end portion 252 of the container. The breech block portion 280 of the housing 276 is then secured to the main body portion 278 of the housing. Preferably, heavy duty screw threads 340 are used to secure the breech block portion 280 of the housing 276 to the main body portion 278 of the housing.

The inflator 240 is actuatable for providing inflation fluid 270. When the initiator 330 receives an actuation signal, the pyrotechnic charge of the initiator 330 is ignited. A pressure wave resulting from ignition of the pyrotechnic charge is directed toward the hemispherical end portion 252 of the container 242. The pressure wave acts upon the hemispherical end portion 252 of the container 242, forcing the container toward the first axial end 286 of the tubular portion 282 of the housing 276. The force applied to the hemispherical end portion 252 of the container 242 breaks the tab 292 from the inner surface 288 of the tubular portion 282 of the housing 276, and the container is propelled toward the end portion 284 of the housing.

During movement of the container 242 toward the end portion 284 of the housing 276, the conical tool 304 penetrates through the rupture disk 260 creating a flow opening 342 (FIG. 7) in the rupture disk. Inflation fluid 270 flows out of the container 242 through the flow opening 342. The force resulting from the flow of inflation fluid 270 out of the flow opening 342 forces the container 242 away from the conical tool 304 and back toward the breech block portion 280 of the housing 270. When the force of the fluid flow overcomes the force resulting from the pressure wave of the actuated initiator 330, the container 242 is propelled back toward the breech block portion 280 of the housing 276. The hemispherical end portion 252 of the container 242 is forced against the breech block portion 280, and the breech block portion stops the container. FIG. 7 illustrates the container 242 adjacent the breech block portion 280 of the housing 276 with inflation fluid 270 flowing out of the container. Inflation fluid 270 flowing from the container 242 passes through the exit ports 302 in the end portion 284 to exit the housing 276.

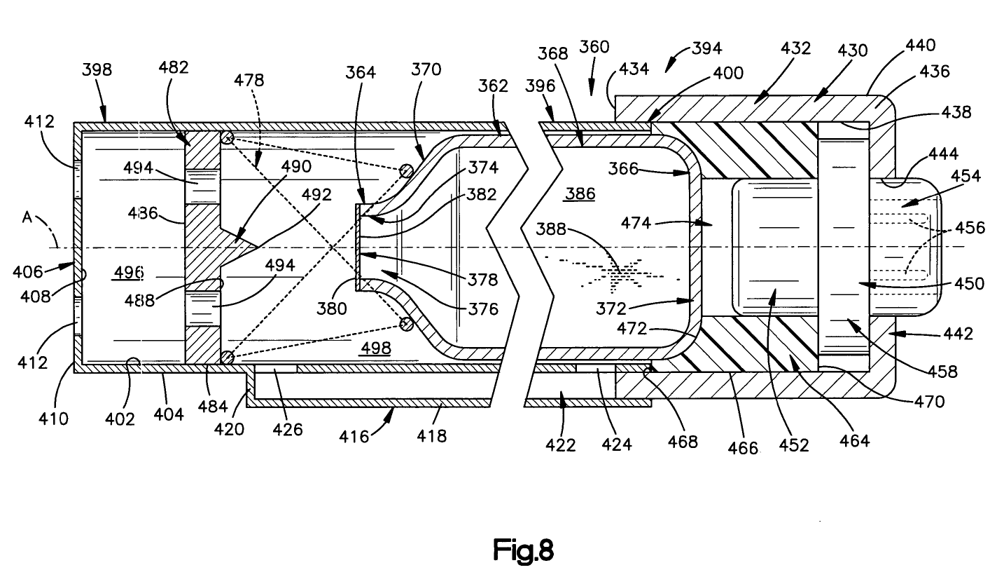

FIG. 8 is a cross-sectional view of an inflator 360 constructed in accordance with a fourth embodiment of the present invention. The inflator 360 of FIG. 8 is in a non-actuated condition. The inflator 360 includes a container 362. The container 362 is generally cylindrical and has opposite first and second axial ends 364 and 366, respectively. The container 362 includes a tubular portion 368, a first end portion 370 and a second end portion 372. The tubular portion 368 is centered on axis A. The first end portion 370 defines the first axial end 364 of the container 362. The first end portion 370 includes a mouth 374 of the container 362. A circular opening 376 extends through the mouth 374 of the container 362. The second end portion 372 defines the second axial end 366 of the container 362. The second end portion 372 closes the second axial end 366 of the container 362.

A rupture disk 378 closes the opening 376 in the first axial end 364 of the container 362. The rupture disk 378 is preferably made of metal and is welded to the mouth 374 of the first end portion 370 to close the opening 376 in the first axial end 364 of the container 362. The rupture disk 378 includes opposite first and second radially extending surfaces 380 and 382, respectively. The rupture disk 378 is adapted to withstand a differential pressure between the first and second surfaces 380 and 382.

A storage chamber 386 is located within the container 362. When the rupture disk 378 closes the first axial end 364 of the container 362, the storage chamber 386 is sealed. A combustible gas mixture 388 is stored under pressure in the storage chamber 386. The combustible gas mixture 388 preferably includes an inert gas, hydrogen, and oxygen or hydrogen and air. The inert gas may be argon, nitrogen, or any suitable inert gas. Trace amounts of helium may be added to the combustible gas mixture 388 to aid in leak detection.

The inflator 360 also includes a housing 394. The housing 394 includes an axially elongated cup-shaped main body portion 396 having opposite first and second axial ends 398 and 400, respectively. In the embodiment illustrated in FIG. 8, the main body portion 396 is formed from high strength steel. The main body portion 396 includes cylindrical inner and outer surfaces 402 and 404, respectively. The inner and outer surfaces 402 and 404 of the main body portion 396 are centered on axis A. The diameter of the inner surface 402 of the main body portion 396 is slightly larger than the diameter of the tubular portion 368 of the container 362. The inner surface 402 of the main body portion 396 is smooth and has a low coefficient of friction. Alternatively, the inner surface 402 may be coated with a material having a low coefficient of friction. Preferably, any coating applied to the inner surface 402 of the main body portion 396 will also have rust inhibiting characteristics.

The main body portion 396 also includes an end wall 406 that closes the first axial end 398 of the main body portion 396. The end wall 398 is circular and is centered on axis A. The end wall 398 includes inner and outer surfaces 408 and 410, respectively. Four exit ports 412 extend axially through the end wall 406. Two of the exit ports 412 are shown in FIG. 8. Alternatively, the exit ports 412 may extend radially through the main body portion 396 of the housing 394 adjacent the end wall 406. The exit ports 412 enable inflation fluid flow out of the housing 394.

The main body portion 396 of the housing 394 also includes a radial extension 416. The radial extension 416 is located radially outwardly of the outer surface 404 of the main body portion 396 and extends partially around the main body portion of the housing 394. The radial extension 416 includes an axially extending outer wall 418, a radially extending end wall 420, and two axially extending side walls (not shown). An axially elongated flow passage 422 is located between the outer surface 404 of the main body portion 396 of the housing 394 and the outer wall 418 of the radial extension 416. Two radially extending ports 424 and 426 extend through the main body portion 396 of the housing 394 and connect with axially opposite ends of the flow passage 422.

The housing 394 also includes a cup-shaped initiator retainer 430. The initiator retainer 430 is preferably formed from high strength steel. A tubular portion 432 of the initiator retainer 430 has axially opposite first and second ends 434 and 436, respectively, and includes cylindrical inner and outer surfaces 438 and 440, respectively. The diameter of the inner surface 438 of the tubular portion 432 is approximately the same diameter as the outer surface 404 of the main body portion 396 of the housing 394. An end wall portion 442 of the initiator retainer 430 closes the second end 436 of the tubular portion 432. A circular aperture 444 extends axially through the center of the end wall portion 442 of the initiator retainer 430.

The inflator 360 also includes a pyrotechnic initiator 450. The initiator 450 includes a first cylindrical portion 452 that contains a pyrotechnic charge (not shown) and a resistive wire (not shown) for igniting the pyrotechnic charge. The pyrotechnic charge of the initiator is ignitable in response to the initiator 450 receiving an actuation signal from the electronic circuitry. A second cylindrical portion 454 of the initiator includes leads 456 for connecting the resistive wire to electronic circuitry (not shown) of a vehicle safety system. A radially extending flange portion 458 of the initiator 450 separates the first and second cylindrical portions 452 and 454.

The housing 394 also includes a breech block 464. The breech block 464 may be a metal casting or a molded thermoplastic part. The breech block 464 includes a cylindrical outer surface 466 and opposite first and second axial ends 468 and 470, respectively. The cylindrical outer surface 466 has a diameter that is approximately equal to the diameter of the inner surface 438 of the tubular portion 432 of the initiator retainer 430. A concave recess 472 extends into the first axial end 468 of the breech block 464. The second axial end 470 of the breech block 464 is planar. An axially extending bore 474 extends between the concave recess 472 and the second axial end 470 of the breech block 464.

The inflator includes a spring 478 for limiting movement of the container 362 relative to the housing 394 prior to actuation of the initiator 450. The spring 478 is preferably a helical spring. The spring 478 helps to prevent unintentional actuation of the inflator 360. For example, the spring 478 may be designed to have a spring constant sufficient to resist movement of the container 362 relative to the housing 394 when the inflator 360 is dropped from a height of four feet.

The inflator 360 also includes a diffuser member 482. The diffuser member 482 is cylindrical and is formed from high strength steel. A cylindrical outer surface 484 of the diffuser member 482 has a diameter that is approximately equal to the diameter of the inner surface 402 of the main body portion 396. The diffuser member 482 also includes opposite first and second radially extending side surfaces 486 and 488, respectively. A conical protrusion 490 extends away from the center of the second side surface 488 of the diffuser member 482 and terminates in a point 492 at a location axially spaced away from the second side surface 488. Four inflation fluid ports 494 extend axially through the diffuser member 482. FIG. 8 illustrates two of the four inflation fluid ports 494.

To assemble the inflator 360 of FIG. 8, the initiator 450 is inserted into the initiator retainer 430 so that the second cylindrical portion 454 of the initiator extends through the aperture 444 in the end wall portion 442 of the initiator retainer. The breech block 464 is then inserted into the initiator retainer 430 so that flange portion 458 of the initiator 450 is interposed between the second axial end 470 of the breech block and the end wall portion 442 of the initiator retainer.

The diffuser member 482 is inserted into the second axial end 400 of the main body portion 396 of the housing 394 so that the first side surface 486 of the diffuser member is nearest the end wall 406 of the main body portion 396. The diffuser member 482 is moved to a location just beyond port 426 (i.e., on a side of port 426 nearer the end wall 406) and is fixed to the main body portion 396 of the housing 394. When the diffuser member 482 is fixed relative to the main body portion 396, a diffuser chamber 496 is defined in the housing 394 between the end wall 406 and the diffuser member 482.

Next, the spring 478 is inserted into the second axial end 400 of the main body portion 396 of the housing 394 and placed in contact with the second side surface 488 of the diffuser member 482. Alternatively, the spring 478 may be secured to the second side surface 488 of the diffuser member 482 prior to the diffuser member being inserted into the main body portion 396.

The container 362, which was previously filled with combustible gas mixture 388 under pressure and sealed with the rupture disk 378, is then inserted into the second axial end 400 of the main body portion 396 so that the first end portion 370 of the container 362 engages the spring 478. The second axial end 400 of the main body portion 396 is then inserted into the first end 434 of the tubular portion 432 of the initiator retainer 430. When the main body portion 396 is inserted into the tubular portion 432 of the initiator retainer 430, the radial extension 416 engages an outer surface 440 of the initiator retainer 430. The main body portion 396 and the radial extension 416 are fixed to the initiator retainer 430. Preferably, the main body portion 396 and the radial extension 416 are welded to the initiator retainer 430. The main body portion 396 of the housing 394 and the initiator retainer 430 collectively define an interior chamber 498 of the housing 394 in which the container 362 is located. The interior chamber 498 of the housing 394 extends axially between the initiator 450 and the diffuser member 482.

The inflator 360 is actuatable for providing inflation fluid. When the initiator 450 receives an actuation signal, the pyrotechnic charge of the initiator 450 is ignited. Pressurized hot gas results from actuation of the initiator 450. The pressurized hot gas is directed into the interior chamber 498 of the housing 394 and toward the second end portion 372 of the container 362. The pressurized hot gas acts upon the second end portion 372 of the container 362 forcing the container toward the diffuser member 482. The force applied to the second end portion 372 of the container 362 overcomes the resistance of the spring force, and the container is propelled toward the diffuser member 482.

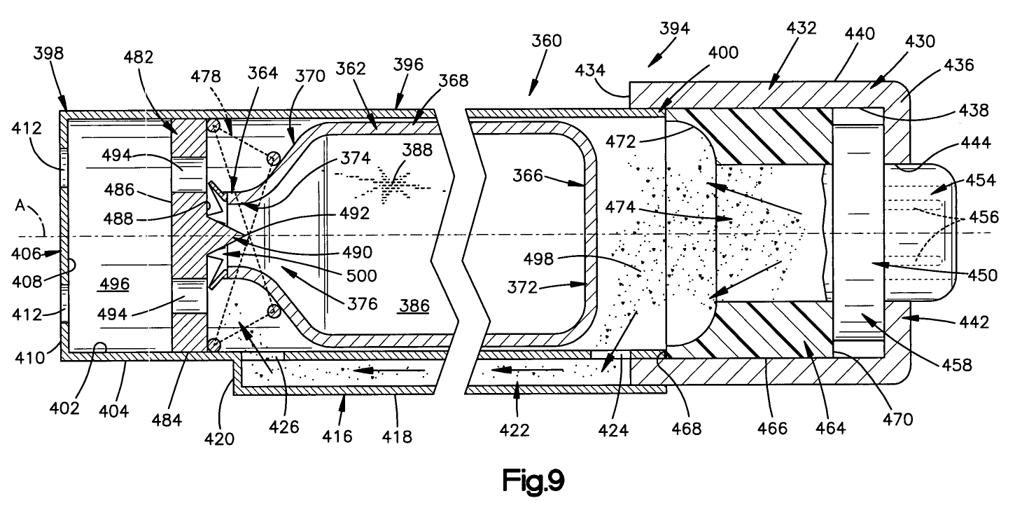

During movement of the container 362 toward the diffuser member 482, the conical protrusion 490 penetrates through the rupture disk 378 creating a flow opening 500 (FIG. 9) in the rupture disk 378. FIG. 9 illustrates the container 362 located adjacent the diffuser member 482 just after the bursting of the rupture disk 378.

When the container 362 is located adjacent the diffuser member 482, as shown in FIG. 9, some of the hot gas from the initiator 450 passes through port 424 into the flow passage 422. The hot gas flows through the flow passage 422, exits port 426, and enter the interior chamber 498 of the housing 394 adjacent the diffuser member 482.

The flow of the hot gas into the flow passage 422 lowers the pressure acting on the second end portion 372 of the container 362. At the same time, the force resulting from the flow of the combustible gas mixture 388 out of the flow opening 500, along with the force of the spring 478 acting upon the first end portion 370 of the container 362, acts to push the container 362 back toward the initiator 450. When the combined force from the flow of the combustible gas mixture 388 and the spring 478 overcomes the pressure acting on the second end portion 372 of the container 362, the container 362 is propelled back toward the initiator 450. The second end portion 372 of the container 362 is forced against the breech block 464 and the breech block stops the container.

The combustible gas mixture 388 flowing out of the container 362 mixes with the hot gas in the interior chamber 498 of the housing 394 adjacent the diffuser member 482. The hot gas ignites the combustible gas mixture 388 and generates inflation fluid. Inflation fluid flows through the inflation fluid ports 494 of the diffuser member 482 and into the diffuser chamber 496. The inflation fluid then exits the housing 394 through the exit ports 412.

From the above description of the invention, those skilled in the art will perceive improvements, changes and modifications. For example, although all of the embodiments described above have generally cylindrical components, components having other shapes are also contemplated by the present invention. Additionally, in the embodiment of FIG. 8, non-combustible inflation fluid under pressure may be stored in the container 362 and the hot gas from the initiator 450 may be used only for heating the inflation fluid. Such improvements, changes and modifications within the skill of the art are intended to be covered by the appended claims.

1. An inflator comprising:
a housing including at least one exit port;
a container in which is stored a fluid under pressure, the container being located in the housing and having opposite first and second ends;
a tool located in the housing adjacent the first end of the container for opening the first end of the container; and
a pyrotechnic device located adjacent the second end of the container and actuatable for propelling the container through the housing and into contact with the tool so as to cause the tool to open the first end of the container and enable a flow of fluid from the container toward the at least one exit port of the housing.

2. The inflator of claim 1 wherein the flow of fluid from the container acts to propel the container back through the housing in a direction away from the tool, a portion of the housing forming at least part of a stop mechanism for limiting movement of the container away from the tool.

3. The inflator of claim 2 wherein the portion of the housing that forms at least part of the stop mechanism is a breech block, the breech block engaging the second end of the container to stop movement of the container away from the tool.

4. The inflator of claim 2 wherein the portion of the housing that forms at least part of the stop mechanism includes a surface that partially defines a groove in an inner surface of the housing, a locking member that is attached to the container engaging the surface to stop movement of the container away from the tool.

5. The inflator of claim 1 further including a member for resisting movement of the container toward tool.

6. The inflator of claim 5 wherein the member is a spring that biases the container away from the tool.

7. The inflator of claim 5 wherein the member is a flexible locking member that is attached to the container, the flexible locking member engaging a surface that partially defines a groove in the housing.

8. The inflator of claim 1 wherein the housing is formed from plastic.

9. The inflator of claim 1 wherein the fluid is a combustible gas mixture, the housing including structure for directing hot gas resulting in actuation of the pyrotechnic device into the flow of the combustible gas mixture from the container so as to ignite the combustible gas mixture.

10. The inflator of claim 1 further including a shield that is located in the housing, the shield preventing debris from entering a portion of the housing, the shield being ruptured during movement of the container relative to the housing.

11. An inflator comprising:
a housing including at least one exit port;
a container in which is stored a fluid under pressure, the container being located in the housing and having opposite first and second ends;
a tool located in the housing adjacent the first end of the container for opening the first end of the container; and
a device that is actuatable for propelling the container through the housing and into contact with the tool so as to cause the tool to open the first end of the container and enable a flow of fluid from the container toward the at least one exit port of the housing;
a portion of the housing forming at least part of a stop mechanism for limiting movement of the container away from the tool in response to the flow of fluid from the container acting to propel the container away from the tool.

12. The inflator of claim 11 wherein the device is a pyrotechnic initiator that is located adjacent the second end of the container.

13. The inflator of claim 12 wherein the fluid is a combustible gas mixture, the housing including structure for directing hot gas resulting in actuation of the pyrotechnic initiator into the flow of the combustible gas mixture from the container so as to ignite the combustible gas mixture.

14. The inflator of claim 11 wherein the portion of the housing that forms at least part of the stop mechanism is a breech block, the breech block engaging the second end of the container to stop movement of the container away from the tool.

15. The inflator of claim 11 wherein the portion of the housing that forms at least part of the stop mechanism includes a surface that partially defines a groove in an inner surface of the housing, a locking member that is attached to the container engaging the surface to stop movement of the container away from the tool.

16. The inflator of claim 11 further including a member for resisting movement of the container toward tool.

17. The inflator of claim 16 wherein the member is a spring that biases the container away from the tool.

18. The inflator of claim 16 wherein the member is a flexible locking member that is attached to the container, the flexible locking member engaging a surface that partially defines a groove in the housing.

19. The inflator of claim 11 wherein the housing is formed from plastic.

20. The inflator of claim 11 further including a shield that is located in the housing, the shield preventing debris from entering a portion of the housing, the shield being ruptured during movement of the container relative to the housing.

21. An inflator comprising:
a plastic housing, at least one exit port extending through the plastic housing, a container in which is stored a fluid under pressure, the container being located in the plastic housing;
structure associated with the plastic housing and actuatable for propelling the container relative to the plastic housing and into contact with a tool for opening the container to enable a flow of fluid from the container toward the at least one exit port of the plastic housing.

22. The inflator of claim 21 wherein the flow of fluid from the container acts to propel the container back through the plastic housing in a direction away from the tool, a portion of the plastic housing forming at least part of a stop mechanism for limiting movement of the container away from the tool.

23. The inflator of claim 22 wherein the portion of the housing that forms at least part of the stop mechanism is a breech block, the breech block engaging the container to stop movement of the container away from the tool.

24. The inflator of claim 21 further including a member for resisting movement of the container toward tool.
